(19) United States
(12) Patent Application Publication
(10) Pub. No.: US 2026/0051219 A1
(43) Pub. Date: Feb. 19, 2026

(54) VIDEO BLENDING DEVICE UTILIZING ARTIFICIAL INTELLIGENCE

(71) Applicant: LNW Gaming, Inc., Las Vegas, NV (US)

(72) Inventor: Martin S. LYONS, Henderson, NV (US)

(21) Appl. No.: 19/289,319

(22) Filed: Aug. 4, 2025

Related U.S. Application Data
(60) Provisional application No. 63/683,963, filed on Aug. 16, 2024.

(51) Int. Cl. G07F 17/32; G06F 40/40; G06T 7/70; G06T 11/60

(52) U.S. Cl. CPC G07F 17/323; G06F 40/40; G06T 7/70; G06T 11/60

(57) ABSTRACT

A video blending device connected to an electronic gaming machine and a player tracking system determines whether to display player tracking content. If so, it captures game images and sends them with a prompt to a large language model (LLM), the prompt configured to determine if a game is active. If not, the video blending device displays the player tracking content. The video blending device also uses prompts to the LLM to determine game button locations and appearances and to generate a new, similar-looking player tracking button, which is then displayed in an appropriate location.

### CROSS-REFERENCE TO RELATED APPLICATIONS

This patent application claims priority benefit of U.S. Provisional Ser. No. 63/683,963 filed Aug. 16, 2024. The disclosure of the 63/683,963 Application is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. Copyright 2024-2025, LNW Gaming, Inc.

### FIELD OF THE INVENTION

This invention relates generally to a gaming system that incorporates player services and, more particularly, to a system and method for integrating gaming functions and player tracking/accounting system functions on a gaming display.

### BACKGROUND OF THE INVENTION

In the 1990s, player tracking/accounting systems emerged as a way to monitor and reward player activity at an electronic gaming machine (EGM), with the primary player tracking/accounting system residing on a back-end computer external to the gaming machine.

Traditionally, EGMs included a main display for game content (e.g., spinning reels, video poker hands) and a separate, smaller display for player tracking/accounting system information (e.g., player account balance, promotional messages). This physical separation often led to underutilization of the secondary display and missed opportunities for enhanced player engagement.

A gaming monitoring unit (GMU) served as an interface between the EGM and the back-end player tracking/accounting system. Early patents, such as U.S. Pat. No. 5,470,079 (LeStrange et al.) and U.S. Pat. No. 5,695,561 (Acres et al.) describe systems that tracked player wagers and time on device to calculate rewards and incentives. U.S. Pat. No. 5,429,361 (Raven et al.) describes a multi-drop bus method of communicating between the GMU and a keypad and display, further enhancing the functionality of player tracking/accounting systems.

U.S. Pat. No. 7,707,242 (DiMichele et al.), titled “Internet browser-based gaming system and method for providing browser operations to a non-browser enabled gaming network,” was filed in 2004 and describes a system for enabling a gaming network to leverage the resources of an auxiliary network, such as the internet, to provide enhanced display functionality on the player tracking/accounting display. A separate hardware component, a player tracking system content manager (“SCM”), connected between the GMU and a video display, allowed for a more interactive and engaging player experience, as well as the ability to offer additional services and features through an enhanced player tracking/accounting display. However, the EGM display and the player tracking/accounting system display remained separate.

U.S. Pat. No. 8,324,935 (Morrow, et al.), titled “Integrated Display and Input System,” was filed in 2001 and discloses a Y adapter that connects the EGM touchscreen to both the EGM processor and the GMU. The gaming display screen of the EGM included a small region that, when selected, activated the player tracking/accounting system's interface. The EGM's game display process recognized when the small region of the display screen was selected and relinquished control of the display screen to the player tracking/accounting system's logic process. The EGM system included a message section on the display screen that was allocated for showing player tracking/accounting system messages to the player of the gaming device. The message section on the display screen was dedicated to control by the player tracking/accounting system's logic process and was free from control by the EGM display process, though the EGM facilitated displaying the content in this region on behalf of the GMU.

U.S. Pat. No. 8,241,123 (Kelly et al.), titled “Video switcher and touch router method for a gaming machine,” was filed in 2009 and expanded on these concepts. A display manager scaled at least one of the EGM's display content and the SCM's player tracking/accounting display content to an altered size, enabling all game content to be simultaneously rendered with all player tracking/accounting content on the EGM's touch screen display. Both the EGM and the SCM were spoofed into believing that they were connected to their own standalone displays. The system also included a coordinate transformation calculation device that received coordinates from an input on the EGM's touch screen game display and considered any scaling or shifting performed on at least one of the displayed game content and the player tracking/accounting system content to transform touch coordinates corresponding to the altered size of the rendered content so that touch inputs to the EGM and the SCM appeared to have originated from their normal locations on a full-sized display.

U.S. Pat. No. 9,305,422 (Steil), titled “Method and apparatus for audio scaling at a display showing content in different areas,” was filed in 2013 and focused on “audio scaling” to enhance the user experience when multiple types of content are displayed simultaneously. Audio from the EGM and the GMU was combined such that it was emitted from speakers located as closely as possible to where their respective video content was displayed on the shared EGM display.

However, challenges remain. The video switching devices (VSDs) described above are typically a separate piece of hardware from the GMU and the SCM, which may or may not be integrated into a single device, attached to a centralized player tracking system. A typical VSD has two video inputs that it combines by first copying the video output from the SCM and then scaling video input from the EGM (the game), drawing the second video input on top of the first output. In this approach, the VSD knows to only generate SCM video content for the areas of the screen not occupied by the game. Uniformly scaling the game can lead to wasted space on the monitor if the game video output is a portrait mode display, for example, a 16×9 game screen. Non-uniformly scaling the game leads to no wasted space but alters the appearance of the game so that it is not displayed as it was intended to be shown. The player tracking/accounting system content must be specially formatted for each possible screen configuration (at least landscape, portrait, 16×9, 4×3), which is time-consuming for content generation, and, since the EGM and the SCM do not interact, the game display may cover any output from the system that may be present in the area where the game is shown. The VSD must be configured to allocate regions to be used for game and player tracking/accounting system content.

Thus, while the above-described patents represent progress in the integration of gaming and player tracking/accounting system functionalities on a shared display or displays, the present invention seeks to build upon this prior art, addressing remaining challenges and further enhancing the player experience in the ever-evolving landscape of electronic gaming machines and player tracking/accounting systems.

### SUMMARY OF THE INVENTION

A video blending device connected to an electronic gaming machine and a player tracking system determines whether to display player tracking content. If so, it captures game images and sends them with a prompt to a large language model (LLM), the prompt configured to determine if a game is active. If not, the video blending device displays the player tracking content. The video blending device also uses prompts to the LLM to determine game button locations and appearances and to generate one or more new, similar-looking, player tracking buttons, which are then displayed in appropriate locations also determined by the LLM.

In accordance with one or more embodiments, a method to display content from a player tracking system on the same screen as a game is disclosed. The method involves checking if the player tracking system wants to show something. If it does, the system captures an image of the game screen and uses an artificial intelligence (AI) large language model (LLM) to determine if the game is actively being played. If the game is not active, the player tracking system content is blended with the game screen image and displayed. If the game is active, the system waits and checks again later.

In accordance with one or more other embodiments, a method to create a custom button for the player tracking system that looks like it belongs to the game is disclosed. The method involves capturing an image of the game screen and using AI to find the location and appearance of existing game buttons. The system then uses AI to generate a new button that matches the style of the game's buttons. Finally, the system finds a suitable place on the screen to display this new button, blends it into the game image at the suitable place and display the blended image.

Other features and advantages of the present invention will become apparent from the following detailed description, taken in conjunction with the accompanying drawings, which illustrate, by way of example, the features of the present invention.

### BRIEF DESCRIPTION OF THE DRAWINGS

FIG. 1 illustrates a relational diagram of a prior art VSD.

FIG. 2 illustrates a relational diagram of a VSD in accordance with one or more embodiments of the present invention.

FIGS. 3, 4, 5, 6, 7A and 7B illustrate various front views of display screens of an EGM in accordance with one or more embodiments.

FIG. 8 is a flow diagram for a data processing method that corresponds to instructions executed by an overlay rules system according to an embodiment of the present invention.

FIG. 9 is a flow diagram for a data processing method that corresponds to additional instructions executed by an overlay rules system according to an embodiment of the present invention.

### DETAILED DESCRIPTION OF THE PREFERRED EMBODIMENTS

A preferred embodiment of the present invention is a video blending device that integrates player tracking/accounting system functions with gaming functions on a video display screen of a gaming device. A single piece of hardware acts as a player tracking/accounting system interface (GMU), a player tracking/accounting display content generator/manager (SCM) and a touch router/display manager that mixes and composes the EGM and player tracking/accounting display content. Notably, there is only one video input from the EGM. Also notable is that, in preferred embodiments, all game content is rendered full screen without any scaling, thus eliminating the above-mentioned problems resulting from scaling. An overlay rules system intelligently determines when it is appropriate to overlay player tracking/accounting system content on top of the game content and, in some embodiments, can automatically generate player tracking/accounting system buttons that match the look and feel of the buttons used in the underlying game.

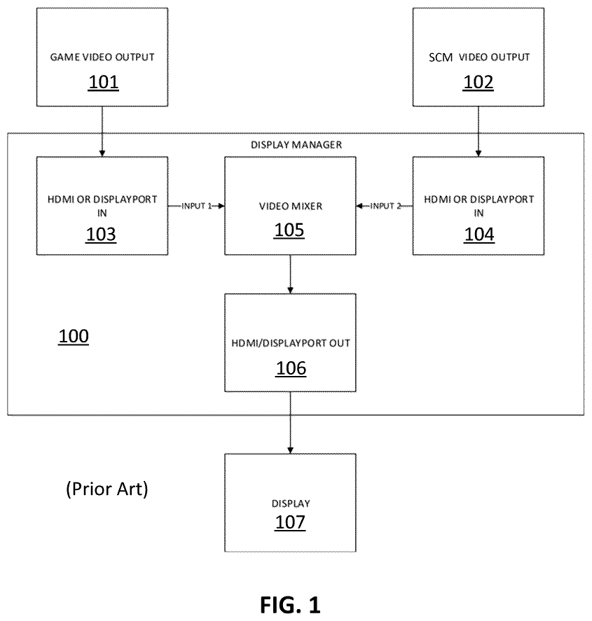

Referring now to FIG. 1, a simplified diagram of a prior art VSD 100 is shown. The VSD 100 is placed between an EGM controller (not shown) and its main game display and any secondary displays 107. The VSD 100 is also located between the SCM of a GMU connected to a player tracking/accounting system via a casino network (all not shown) and the EGM's displays.

The VSD 100 is a separate hardware device from the GMU and SCM (though the GMU and SCM may be a single integrated component) with at least one processor, a memory storing for storing programming and multiple input ports including video input ports 103, 104 and a controller port (not shown). The VSD 100 receives one or more video signals 101 from the EGM controller and one or more video signals 102 from the SCM and displays the content associated with those signals on one or more shared displays 107.

The VSD 100 employs a video mixer 105 to switch (e.g., arbitrate, redistribute, or the like) video output 101 from the EGM (received by a first video input port 103) and video output 102 from the player tracking/accounting (received by a second video input port 104). The resulting combined video output is sent from the video mixer 105 to the video display(s) 107 via a video output port 106. Preferably, the video switching is controlled by the player tracking/accounting system or controlled by one or more other central configuration servers over Ethernet.

While typically HDMI, the video signal inputs 101, 102 and output 106 may also be 9-pin Video Graphics Array (VGA), 15-pin Super VGA, Low-voltage differential signalling (LVDS), Digital Visual Interface (DVI), DisplayPort (DP), etc., or any combination thereof. The controller port may be RS-232 Serial, USB, Ethernet, and the like. The content associated with one video signal may be presented alone on the display 107, with content associated with the other signal absent from that image, or the content associated with multiple signals may be simultaneously displayed on the shared display 107.

The screen may be split between the content associated with multiple signals, or the content associated with one or more signals may overlay the content associated with one or more background signals. The overlaid content may completely obscure the background content or may provide a level of transparency by allowing the background content to be partially or completely visible. Also, the overlaid content may provide different levels of transparency in different areas of the display, effectively superimposing an image on top of the background content. The VSD 100 receives commands from a device or server via Ethernet connection, preferably the player tracking/accounting system, directing the VSD 100 to split, overlay, superimpose, and otherwise share the display 107 among the content associated with the video input signals. The VSD 100 enables a wagering game running on the EGM and the system information rendering software running on the SCM to remain completely independent of each other, executing on single or multi-core CPUs located on completely separate electronic devices.

The VSD 100 includes a touch router device (“TRD”) (not shown) that receives touch signals from micro-controllers located on each of the touch displays, the signals specifying the physical coordinates of a touch. The shared displays'touch controllers may communicate with the VSD using RS-232 serial ports, USB ports (possibly utilizing a USB hub), a combination of the two, or conversion of one to another. The VSD's touch controller driver receives the touch signals from the microcontroller(s) and converts their signals to physical screen coordinates. The TRD determines the video source associated with the content at those coordinates and any scaling or shifting performed on the content, then calculates physical coordinates from a perspective of the content's source device. It then sends simulated touch micro-controller signals and commands to the touch device driver on the source device either through RS-232 serial ports or USB ports (possibly utilizing a USB hub), a combination of the two, or conversion of one to another. Thus, the TRD determines the source of the video images displayed at the touched physical screen coordinates and calculates any coordinate transformation needed to accommodate any scaling or shifting performed on the video signal as it was mixed (e.g., switched, arbitrated, redistributed, or the like) for use on the display 107. The TRD then sends the relative coordinates (de-scaled and de-shifted) to the appropriate source device, the EGM or SCM, by mimicking its touch controller.

This combined video switching/touch router device enables a wagering game running on the EGM and the player tracking/accounting system information rendering software on the SCM to remain completely independent of each other, executing on single or multi-core CPU's located on completely separate electronic devices, but with one or more shared touch displays.

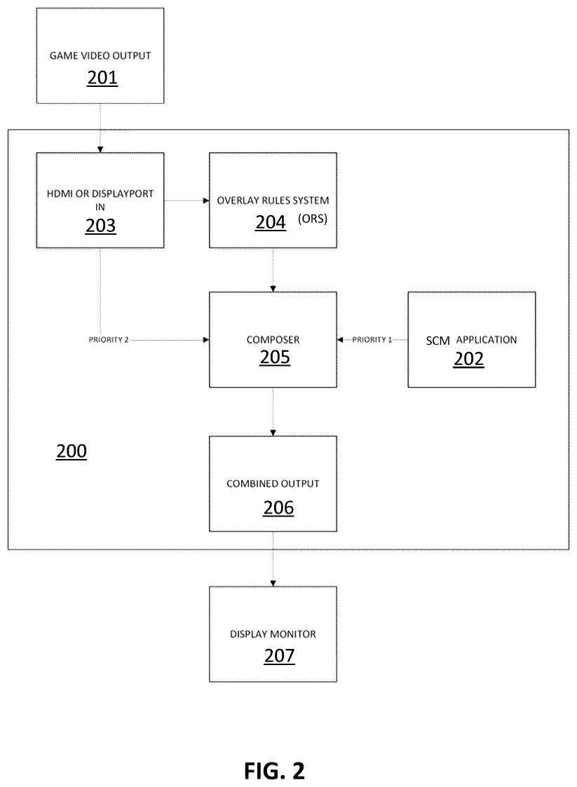

The present invention provides an improved display and input system for players and casino employees. FIG. 2, in accordance with one or more embodiments, illustrates differences between a video blending device (VBD) 200 of the present invention and the VSD 100 of the prior art. While also having at least one processor, a memory for storing programming and a plurality of input ports, notably, there is only one video input 201 from the EGM. Video signals from the EGM are received at video input port 203. The same hardware that hosts and renders the player tracking/accounting application 202 also performs video mixing and composing via a composer 205 to produce combined video output to the display 207 via a video output port 206. The combined hardware is more cost effective than prior art solutions and allows for better ways of combining video content, as will be described below.

Furthermore, in preferred embodiments, all game content is rendered full screen without scaling, eliminating the aforementioned scaling-related issues. While the VBD 200 of the present invention can replicate the functionality of the prior art VSD 100, keeping game content full screen eliminates problems resulting from scaling, including the need to intelligently scale touch coordinates sent to the EGM and SCM. But because the game will be full screen, displaying player tracking/accounting content without interfering with game operation presents a challenge. As in prior art solutions, the EGM is not expected to have any awareness of the player tracking/accounting content—as far as it is concerned, it can and does use the whole of the display 207 as its canvas. To address these issues, the present invention's VBD 200 employs an overlay rules system (ORS) 204.

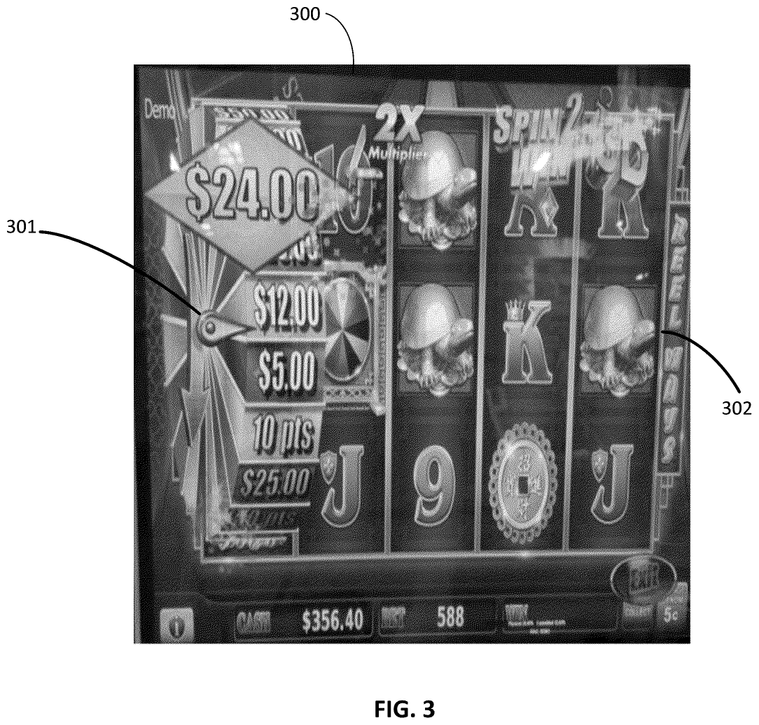

FIG. 3 illustrates game screen 300 containing a bonus wheel 301 generated by the player tracking/accounting application (integrated GMU/SCM) 202 overlaid on top of a reel-spinning game 302 generated by the EGM. Because the EGM is unaware of the bonus wheel 301, it may cause the game reels to spin hidden underneath the wheel. This is undesirable. The ORS 204 aims to prevent such undesirable occurrences.

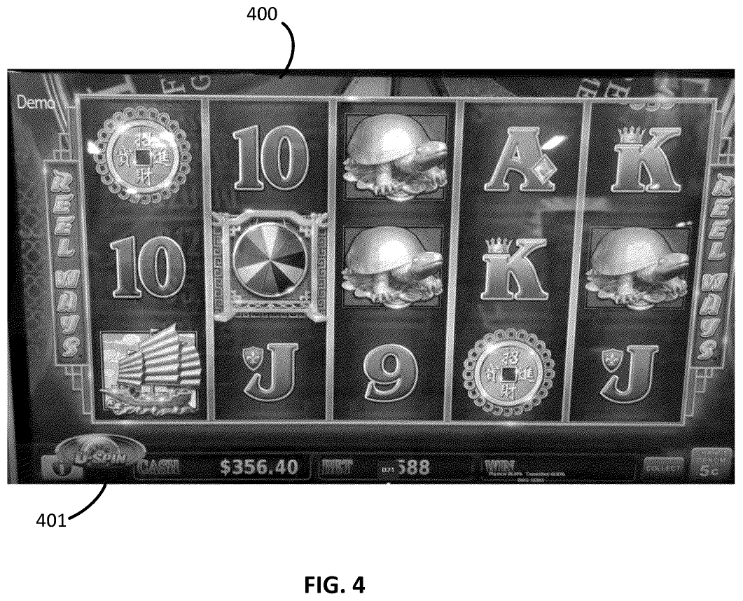

FIG. 4 illustrates an image of a game screen 400 containing an onscreen button 401 to activate the bonus wheel 301. The button is not perfectly positioned (though techniques to correct this are discussed further below), but it does not overlay any meter values or reels generated by the EGM and, thus, does not mask or impede play of the game. The ORS 204 would permit this button to appear, allowing activation of the wheel bonus, only if it is determined that such action will not interfere with game play. Furthermore, once the bonus game is overlaid, additional logic may disable the underlying game until the bonus game concludes.

Alternatively, if the player attempts to activate the reel game, the ORS 204 can detect this and prompt the player tracking/accounting application 202 to temporarily pause or fade out the bonus wheel 301, replacing it with button 401 until it is safe to re-display the wheel. In some embodiments, the player tracking/accounting application 202 may continually poll the ORS 204 at regular intervals, enabling or disabling various bonus or user interface features depending upon an ‘EGM game active/inactive’ determination made by the ORS 204.

Various methods can be employed to determine whether the EGM game is active. For example, the ORS 204 may monitor player tracking/accounting data between the EGM and the back-end system (for example, using the SAS protocol). This is readily accomplished since, unlike in legacy solutions, the ORS 204 is part of the same hardware used to host the GMU logic that interfaces the EGM to the back-end system. The ORS 204 is thus able to detect and use, for example, certain data within SAS traffic such as the start/end points of games, signals of wins awarded. The ORS 204 may also determine, when none of this data is present in the SAS data, that a suitable period of idle time has elapsed. In some embodiments, the VBD 200, and, indirectly, the ORS 204, may have an audio input (not shown) connected to an audio output of the EGM and use the heuristic that inactive games are generally quieter than active games.

Another possible method that is more precise than SAS data or analysis of audio levels employs artificial intelligence (AI) to detect game activity. Recent developments of new AI large language model (LLM) systems like ChatGPT, LLama or Gemini make this possible.

These LLMs achieve their impressive results in reasoning and analysis by predicting sequences of text in response to a given input-the ‘prompt.’ For the initial releases of ChatGPT et al, these tokens were usually strings or words of text. A prompt to an AI LLM might be, for example, ‘Why is the sky blue?’ The AI would ingest these tokens and generate further tokens that would represent text explaining that blue light is scattered because it travels in shorter, smaller waves than other colors of the spectrum.

Even more recently has been the development of multimodal LLMs. While ChatGPT and Gemini were early examples, numerous multimodal LLMs are now available, including open-source models that can run on modest hardware. A multimodal LLM can take an image, or a video stream comprised of many images, and convert this into tokens along with text to create a multimedia prompt. This allows AI reasoning about an image or series of images.

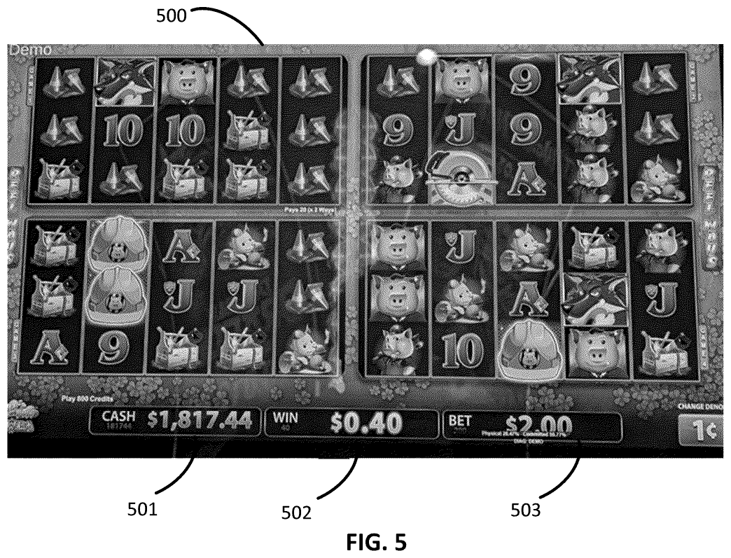

FIG. 5 illustrates an image 500 captured with a phone camera pointed at an EGM display. This image was then passed into the open source ‘PaliGemma’ model (from Google) along with the following text prompt: “Please tell me the credits/cash, win amount and bet amount that you see.” The response from the model was: “181744, $0.40, $2.00.” Notably, the PaliGemma model correctly identified the cash meter 501, win meter 502, and bet meter 503 and extracted the correct values, despite having no prior exposure to this game or specific training for this task, and even with the bet meter partially obscured.

It should be noted that techniques such as optical character recognition (OCR) and convolutional neural networks (CNNs) may also be used to read text from an image, but these are harder to set up because they must be trained or provided with example fonts. However, in some embodiments, a hybrid approach may be used. During initial EGM and VBD setup, the meter areas may be detected using an LLM. OCR or CNN approaches used during game play to determine actual values. This approach significantly reduces computational load while leveraging the LLM's ability to identify meters across diverse game displays from various manufacturers, as all EGMs in a casino, regardless of origin, connect to the backend player tracking/accounting system.

With the use of AI, some rules for the ORS 204 may include: If cash or credits is zero and has been zero for at least a predetermined period of time, allow the player tracking/accounting content to overlay over the game content. If cash or credits meters are not found, then the game must be in an attract mode and allow the player tracking/accounting content to overlay the game content. If cash or credits is not zero, and the game is not playing (see below), allow the player tracking/accounting content to overlay the game content. Otherwise disallow the player tracking/accounting content overlaying the game content.

The determination of whether game play is underway may be accomplished by asking the LLM a further question about the game image 500: “Is the game in progress?”. This may seem like a difficult question to answer when you consider that even an inactive game with no one present can have a lot of activity on it. Games often include attract modes that demonstrate game features when no one is actively playing the game and may appear to be in the middle of a game cycle. However, the ORS 204 may not need to ask if a game is in progress if the cash/credit meter is zero or not present. The prompts may be further refined. For example: “Is the game in progress, in attract mode or waiting for the player to press start?”. The LLM may then look for clues in the image(s) according to the above examples.

In other embodiments employing AI to determine if the reels are spinning or other game activity is in progress, the ORS 204 may subtract a previous frame captured from the game from a current frame and provide this delta to the LLM with a prompt explaining that the image is a delta. In still other embodiments, the ORS 204 may stack the previous frame on top of the current frame and prompt the AI accordingly. For example: “This image contains two screen captures from a game taken one second apart. The previous capture is above the latest capture. Do the two screen captures indicate that a game in progress?” Alternatively, multimodal LLMs are commercially available that natively accept video input of many frames, relieving the ORS 204 from the task of building delta or images from multiple frames.

In embodiments employing a multimodal LLM, fine-tuning the model with techniques like low-rank adaptation (LoRA) may enhance accuracy. Fine-tuning consists of training the AI in advance with known examples. For example, the LLM may be provided with hundreds of images of various games that are either inactive, in progress or in attract mode, along with the same prompt (e.g. “Is the game in progress, in attract mode or waiting for the player to press start?”) and the correct answer for each image. This allows the LLM to learn what it means to be ‘in attract mode,’ ‘in progress,’ or ‘waiting.’ LoRA is a technique designed to refine large language models. Unlike traditional fine-tuning methods that require extensive retraining of the entire model, LoRA focuses on adapting only specific parts of the neural network. This approach allows for targeted improvements without the need for comprehensive retraining, which can be time-consuming and resource intensive.

In still other embodiments, other LLM technologies may also be used. Distillation is a technique where a smaller LLM (the ‘student’) is trained to mimic the behavior of a larger LLM (the ‘teacher’). Preprocessing approaches such as fine-tuning and distillation decrease the amount of real-time computational resources required by the VBD when deployed in the casino.

In some embodiments, the LLM may not run on the VBD installed in or at the EGM. Rather, it may be hosted on a server elsewhere, for example, as part of the player tracking/accounting backend server or in the cloud. For performance optimization, the ORS 204 may send images/videos to the LLM periodically, such as once per second. This allows activation of player tracking/accounting content within a reasonable time after a game cycle is completed while greatly reducing the resource requirements of each individual VBD.

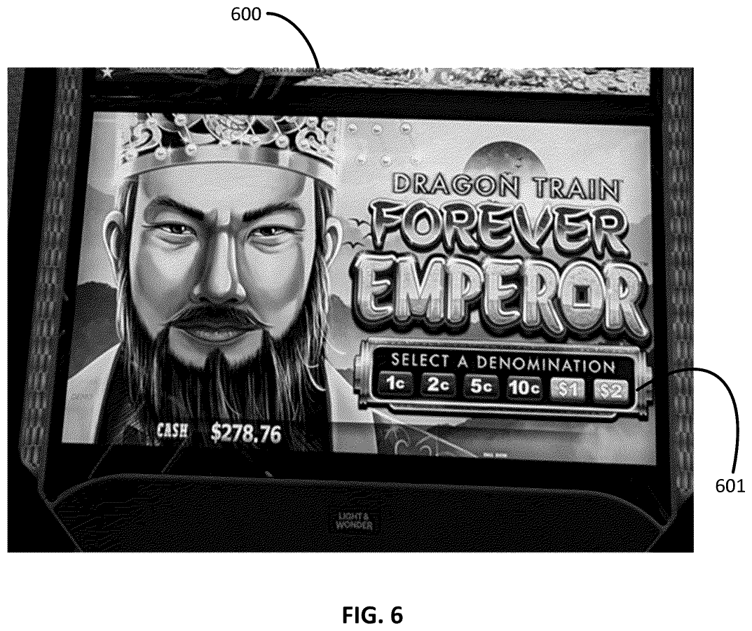

Another example of an image 600 that could be indicate that the game is inactive is shown in FIG. 6. In this example, a ‘Select A Denomination’ menu 601 is shown. This is a common display shown when a game is inactive. An appropriate prompt might be: “Is the game in progress, in attract mode, waiting for the player to press start, or waiting for a denomination to be selected?”

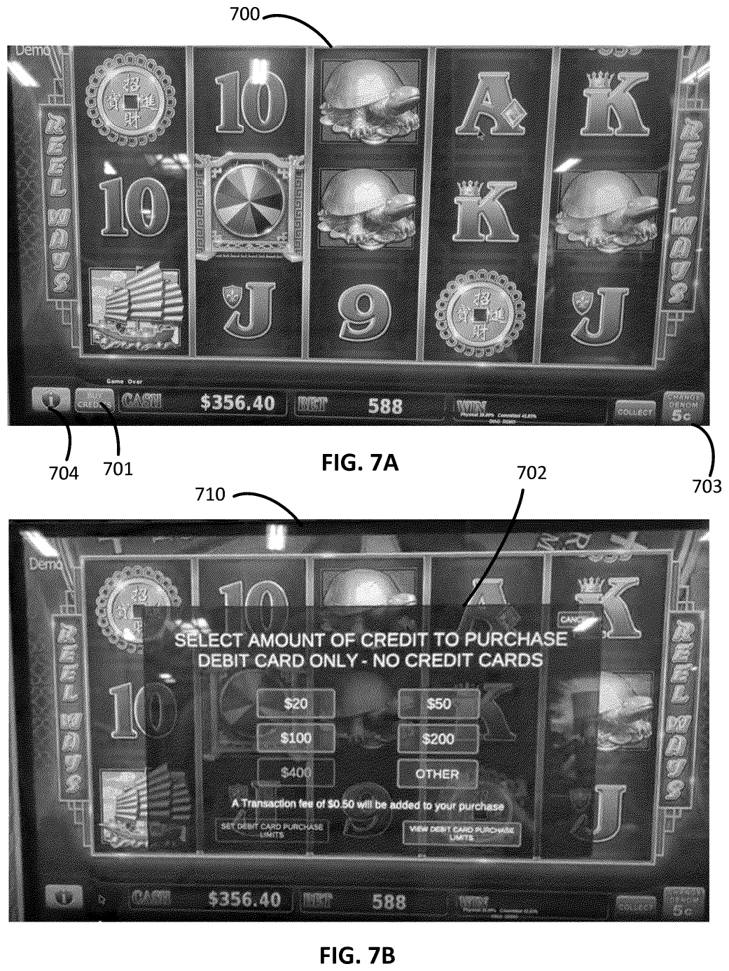

FIGS. 7A and 7B illustrate another example. In FIG. 7A, the player may press the ‘Buy Credits’button 701. It should be noted that, even though the button 701 appears to have been generated by the EGM, along with all of the other game buttons, the ‘Buy Credits’button 701 is actually content provided by the player tracking/accounting application 202. In the image 700 shown in FIG. 7A, it is the only content being rendered by the player tracking/accounting application 202.

The placement and design of the button 701 illustrate other aspects of the present invention. In some embodiments, the placement may be done manually during a setup phase, wherein a technician may mark one or more areas of the screen that are suitable for placing the button 701 without interfering with underlying important game content. Preferably, however, a Multimodal LLM automatically performs this task. When suitably fine-tuned with some examples, the LLM can be prompted to ‘return coordinates that would be appropriate to place a UI element the size of the attached example button on the attached game screen image such that the button will not interfere with the important game elements shown in the game screen image.’

To further refine this process, heuristics or further additions to the LLM prompt may also consider that it should not return a result if the screen image from the game indicates that the EGM was in attract mode when the image was captured, as it does not represent a usable view of the game. Alternatively, the LLM (or a computer vision application) may be prompted to return the areas of the screen that represent the meters, the reels or other critical areas that should not be overwritten.

In still other embodiments, the design of the button 701 may be generated by an LLM. While a standard button image can be used, it may be beneficial to match the style of the button 701 to the buttons of the underlying game content. This makes the player tracking/accounting user interface (UI) consistent with the game, which may be beneficial for features like advertising, where it may be intended to not draw attention to the fact that the player tracking/accounting application 202 and EGM game are two distinct systems that do not overly interact. For instance, a ‘ControlNet’ model can generate a new image based on an input image and a prompt. One example of a Controlnet can be found at https://huggingface.co/lllyasviel/control_v11e_sd15_ip2p—Controlnet Instruct Pix2Pix).

In this approach, during setup, a multimodal LLM receives a game screenshot and a prompt like: ‘Identify the coordinates and size of the denomination button (typically displaying a value like ‘$1’). If not found, identify the coordinates and size of an information button, usually marked with an “i.”’ FIG. 7B illustrates a screen image 710 containing examples of the denomination button 703 and the information button 704 referenced in the above prompt. With the returned coordinates, the LLM can then extract the detected button image(s) 703, 704 from the game and pass them into the Controlnet LLM with a prompt of “Change the text of the attached button image to ‘Buy Credits’” or “Make a button in this style with a text of ‘Buy Credits’and change the color of the button to green.’” The returned custom button image with the appearance of button 701 may then be stored by the player tracking/accounting application 202 as an asset to be used whenever it wants to display the ‘buy credits’button 701.

In FIG. 7B, because the game is idle and the player has pressed the button 701 requesting it, the player tracking/accounting application 202 superimposes, via the ORS 204 and composer 205, a menu 702 for selecting the amount of credit to purchase. (In this example, choosing $400 or setting debit card purchase limits are disabled.) Even though there is active game content visible behind the menu 702, such as reel symbols, these are still visible because the menu is alpha-blended when composited by the composer 205 onto the game input image 201. Each player tracking/accounting content button and the whole menu background is 50% transparent. The only content rendered with zero transparency is the text on each button or the menu. These elements are such a small percentage of the overall content that they do not affect easy viewing of the game content underneath. Thus, some player tracking/accounting content may be designated as being ‘game safe,’ capable of being displayed no matter what the state of the underlying game. Button 701 is an example of this type of content.

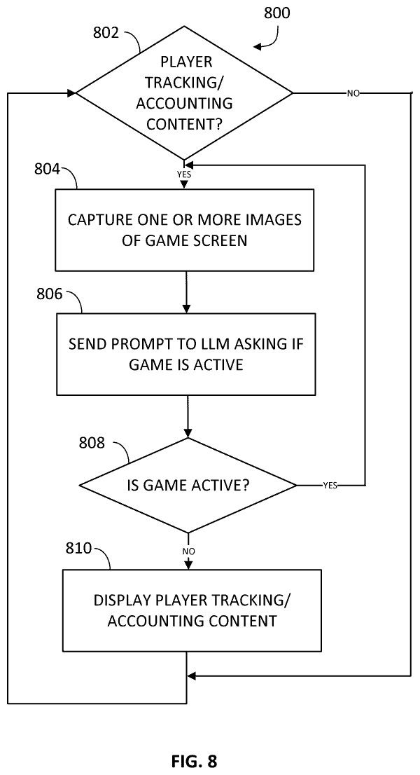

Referring now to FIG. 8, a flow diagram representing one data processing method 800 corresponding to at least some instructions stored and executed by the ORS 204 in FIG. 2 to perform operations according to embodiments of the present invention is shown. The data processing method is described below in connection with the above examples for detecting game activity, or lack thereof, via the use of artificial intelligence.

In step 802, the ORS 204 determines whether the SCM portion of the VBD desires to display new player tracking/accounting system content. For example, this may be because the player pressed button 401 to invoke a bonus game or pressed button 701 to buy credits. If not, flow returns to step 802 until such display is desired.

In step 804, because display of new player tracking/accounting system content is desired, the ORS 204 captures one or more still images or a video clip containing a number of frames of the game screen. In step 806, these frames and a prompt designed to determine whether the EGM game is currently in an active game cycle (e.g. being played) are sent to a multimodal LLM as described above.

At step 808, if the game is in an active game cycle, flow returns to step 804 to perform a new check for game activity using refreshed screen images. This process continues until it is determined that the current game cycle is complete, at which point flow proceeds to step 810.

At step 810, once the underlying game is idle, the player tracking/accounting information is displayed and flow proceeds to step 802 to repeat the process.

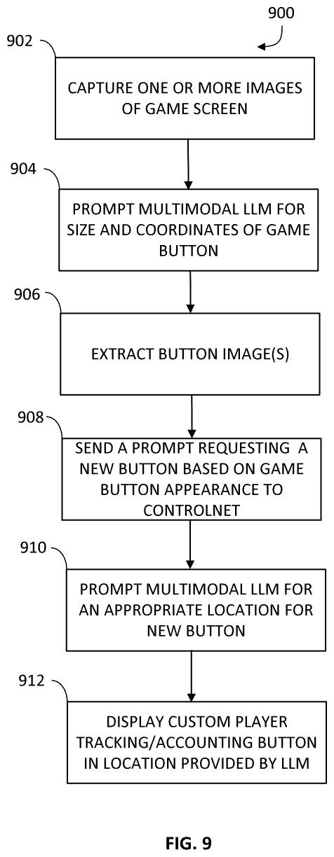

Referring now to FIG. 9, there is shown a flow diagram representing one data processing method 900 corresponding to at least some instructions stored and executed by the ORS 204 in FIG. 2 to perform operations according to embodiments of the present invention. The data processing method is described below in connection with the above examples for detecting the locations and appearance of game buttons and crafting one or more player tracking/accounting buttons of similar appearance via the use of artificial intelligence.

In step 902, the ORS 204 captures one or more still images or a video clip containing a number of frames of the game screen.

In step 904, these frames and a prompt designed to determine the coordinates and size of one or more underlying game buttons (such as the denomination button 703 or information button 704) are sent to a multimodal LLM as described above.

In step 906, the LLM returns extracted copies of the detected button image(s) from the game image(s) to the ORS 204.

In step 908, the ORS 204 send the extracted image(s) to a ControlNet LLM with a prompt requesting a new button image similar in appearance to the extracted images. The prompt may request that the new custom button display certain text and be of a particular color. In some embodiments, the LLM may have previously been provided with a game screen image and asked to provide a list of one or more button colors not used by the game.

In step 910, the ORS 204 asks the multimodal LLM for an appropriate unused location for the new custom button.

In step 912, the new custom player tracking/accounting button is displayed in the provided location so that it blends in with the buttons displayed by the underlying game.

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention.

For example, each prompt described above may be split into multiple parts, each part sent separately to its associated LLM. As a non-limiting example, one or more images may be sent in an initial prompt together with text indicating that the images are of a game screen. A second text prompt may then be sent to the LLM asking whether the EGM is in an active game cycle.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method for displaying player tracking/accounting system content on a display screen connected to a video blending device that is in turn connected to an electronic gaming machine (EGM) and a backend player tracking/accounting system, the video blending device comprising a processor, a memory, and a video input port to receive video signals from the EGM, the method comprising:
determining, by the processor, whether the player tracking/accounting system content is to be displayed on the display screen;
in the event that the player tracking/accounting system content is to be displayed, capturing, by the processor, one or more images of the display screen from the video input port;
sending, by the processor, to a large language model (LLM), a prompt configured to query the LLM whether the EGM is in an active game cycle;
receiving, by the processor, a response from the LLM indicating whether the EGM is in an active game cycle;
in the event that the response indicates that the EGM is in an active game cycle, repeating the capturing and sending steps; and
in the event that the response indicates that the EGM is not in an active game cycle,
blending, by the processor in the memory, the player tracking/accounting system content and a current image of the display screen captured from the video input port, the blending creating a composite image and
displaying, by the processor, the composite image on the display screen.

2. The method of claim 1, wherein the prompt comprises text and the one or more images of the display screen captured from the video input port.

3. The method of claim 1, wherein the LLM is a multimodal LLM.

4. The method of claim 1, wherein the LLM is hosted on the video blending device.

5. The method of claim 1, wherein the LLM is hosted on a server or in the cloud.

6. The method of claim 1, wherein the LLM has been fine-tuned with examples of images of games that are inactive, in progress, or in attract mode.

7. The method of claim 1, wherein the LLM has been fine-tuned using low-rank adaptation (LoRA).

8. The method of claim 1, wherein the one or more images comprise a video clip containing a number of frames of the display screen.

9. The method of claim 1, wherein the one or more images comprise a previous frame captured from the game subtracted from a current frame.

10. The method of claim 1, wherein the one or more images comprise a previous frame captured from the game stacked on top of a current frame.

11. A method for displaying a custom player tracking/accounting system button on a display screen connected to a video blending device connected to an electronic gaming machine (EGM) and a backend player tracking/accounting system, the video blending device comprising a processor, a memory, and a video input port to receive video signals from the EGM, the method comprising:
capturing, by the processor, one or more images of the display screen;
sending, by the processor, a first prompt to a large language model (LLM), the first prompt configured to determine the coordinates and size of one or more game buttons in the one or more images of the display screen and to request extraction of a copy of a game button from the one or more game images;
receiving, by the processor, the copy of the game button from the LLM;
sending, by the processor, the copy to a ControlNet LLM together with a second prompt requesting a new button image similar in appearance to the copy;
receiving, by the processor, the new button image from the ControlNet LLM;
sending, by the processor, a third prompt to the LLM to determine an appropriate unused location for the new button image; and
blending, by the processor in the memory, the new button image at the provided location with a current image of the display screen captured from the video input port to create a composite image; and
displaying, by the processor, the composite image on the display screen.

12. The method of claim 11, wherein the first prompt, the second prompt and the third prompt comprise text and one or more images.

13. The method of claim 11, wherein the LLM is a multimodal LLM.

14. The method of claim 11, wherein the LLM is hosted on the video blending device.

15. The method of claim 11, wherein the LLM is hosted on a server or in the cloud.

16. The method of claim 11, wherein the LLM has been fine-tuned with examples of images of games that are inactive, in progress, or in attract mode.

17. The method of claim 11, wherein the LLM has been fine-tuned using low-rank adaptation (LoRA).

18. The method of claim 11, wherein the one or more images comprise a video clip containing a number of frames of the display screen.

19. The method of claim 11, wherein the second prompt requests that the new custom button display certain text.

20. The method of claim 11, wherein the second prompt requests that the new custom button be of a particular color.
